(19) United States
(12) Patent Application Publication
(10) Pub. No.: US 2026/0332459 A1
(43) Pub. Date: Oct. 22, 2026

(54) NEURAL-NETWORK-ASSISTED ENHANCED MLSE ADAPTATION FOR SERDES RECEIVER

(71) Applicant: Elaine Jiaqi Xia, Sunnyvale, CA (US)

(72) Inventor: Elaine Jiaqi Xia, Sunnyvale, CA (US)

(21) Appl. No.: 19/690,480

(22) Filed: May 28, 2026

(51) Int. Cl. H04L 25/03; H04B 10/69; H04L 1/00; H04L 25/49

(52) U.S. Cl. CPC H04L 25/03165; H04B 10/6971; H04L 1/0039; H04L 25/03267; H04L 25/4917; H04B 10/60; H04B 10/616; H04B 10/69; H04L 1/0054

(57) ABSTRACT

A system performs dynamic enhanced maximum likelihood sequence estimation adaptation for an interconnect interface between AI-accelerating processors participating in a collective operation. An interconnection system includes a communication channel between two AI-accelerating processors and a SerDes receiver having an analog front end, an equalizer, and a signal decoder. The analog front end receives modulated signals conveyed through the communication channel as part of the collective operation, and the equalizer performs front-end equalization to generate post-equalization signals. The signal decoder performs dynamically enhanced MLSE trellis-based sequence detection using dynamically decoded forward error correction results as feedback for changing channel conditions by obtaining the decoded results, computing corrected symbol paths, determining path-distance metrics from mismatch information between estimated symbol paths and the corrected symbol paths.

### FIELD

The present description is related to signal decoding of a connection between hardware components.

### BACKGROUND

High-speed serializer-deserializer (SerDes) links can be exposed to channel impairments that make reliable symbol recovery increasingly difficult as signaling rates and modulation densities increase. Optical and electrical channels may exhibit attenuation, frequency-dependent loss, inter-symbol interference, nonlinear distortion, and other waveform degradations that alter the relationship between a transmitted symbol sequence and a received signal. In multi-level signaling environments, these impairments can reduce decision margin and make it more difficult for receiver circuitry to distinguish among adjacent symbol levels with sufficient accuracy for sustained high-throughput communication.

Conventional receiver adaptation techniques may also have difficulty tracking channel behavior that changes during operation. Interconnect conditions may vary due to temperature drift, link aging, traffic-dependent behavior, manufacturing variation, or other time-varying effects, and parameters selected during an initial calibration interval may become less representative of later operating conditions. As a result, a receiver that relies on static or slowly updated assumptions regarding noise or channel response may experience reduced decoding accuracy when deployed in dynamic communication environments.

Sequence-detection approaches such as maximum likelihood sequence estimation can improve performance relative to purely local symbol decisions, but practical implementation in high-speed links still presents technical challenges. Trellis-based detection depends on path metrics and noise assumptions that influence how candidate symbol sequences are ranked over time. When those assumptions do not adequately reflect actual channel conditions, a detector may favor an incorrect path over a correct path, and that divergence may persist across successive trellis intervals. Such behavior can increase error propagation and complicate reliable sequence recovery in channels affected by nonlinear or data-dependent impairments.

Additional technical difficulty arises from the need to use post-detection information in a manner that supports receiver adaptation without disrupting throughput-sensitive link operation. Error-correction processing may reveal that previously selected symbol decisions were inaccurate, but integrating such information into ongoing signal-detection behavior can be complex, particularly where corrected outcomes become available only after decoding stages have already acted on earlier assumptions.

In high-speed interconnect systems, there is therefore a continuing technical challenge in decoding results and incorporating that information into receiver-side processing quickly and coherently enough to maintain robust communication performance. These challenges are especially acute in communication fabrics that support data exchange among processing devices engaged in distributed computing workloads. Accordingly, improving receiver-side handling of changing channel conditions, sequence-selection uncertainty, and data-dependent impairment remains an important technical issue in the design of high-speed SerDes communication systems.

### SUMMARY

In some embodiments, a system for performing dynamic enhanced maximum likelihood sequence estimation (MLSE) adaptation for an interconnect interface between AI-accelerating processors is described. The system may include a plurality of AI-accelerating processors configured to participate in a collective operation. The system may also include an interconnection system comprising: an optical channel connecting between two of the AI-accelerating processors. The system may further include a SerDes receiver comprising: an analog front end configured to receive modulated signals via the optical channel connecting between the AI-accelerating processors, wherein the modulated signals are part of the collective operation between the AI-accelerating processors. The system may further include an equalizer configured to perform a front-end equalization on the modulated signals to generate post-equalization signals. The system may further include a signal decoder configured to perform dynamic enhancements of MLSE trellis-based sequence detection on the post-equalization signals, wherein the dynamic enhancements are based on dynamically decoded forward error correction (FEC) results as feedback to account for changing channel conditions of the optical channel between the AI-accelerating processors, wherein the dynamic enhancements of the MLSE trellis-based sequence detection comprise: obtaining the dynamically decoded FEC results for the post-equalization signals, computing corrected symbol paths for the MLSE trellis-based sequence detection that are derived from the dynamically decoded FEC, determining path-distance metrics from mismatch information between estimated symbol paths of the MLSE trellis-based sequence detection and the corrected symbol paths, inputting the path-distance metrics to a neural network to generate one or more MLSE-related parameters, the one or more MLSE-related parameters comprising data-dependent sigma and a path-selection weighting value, applying the one or more MLSE-related parameters generated by the neural network to the MLSE trellis-based sequence detection to dynamically adjust the MLSE trellis-based sequence detection. The system may further include wherein the signal decoder is configured to decode the modulated signals at least partially using the dynamic enhancements to the MLSE trellis-based sequence detection to complete the collective operation between the AI-accelerating processors.

In some embodiments, the equalizer is configured to comprise one of feed forward equalization (FFE) and decision feedback equalization (DFE).

In some embodiments, the signal decoder is configured to obtain corrected-symbol references derived from dynamically decoded FEC outcomes, and compare the corrected-symbol references with known reference signals to determine the corrected symbol paths.

In some embodiments, the signal decoder is configured to determine path-distance metrics including a difference between a maximum-likelihood path and a second-most-likelihood path in at least one recent trellis interval.

In some embodiments, the neural network comprises a multilayer perceptron having at least one hidden layer and at least one nonlinear activation, and wherein the neural network is configured to output at least one of an updated data-dependent sigma value and one or more updated transition-weighting terms.

In some embodiments, the nonlinear activation is tanh.

In some embodiments, the signal decoder is configured to further output a desired target path, update a noise parameter sigma, and apply a correction rule to the desired target path and the noise parameter sigma.

In some embodiments, the path-selection weighting value modifies a relative contribution of candidate-state transition among multiple pulse amplitude modulation (PAM) symbol values in the MLSE trellis-based sequence detection.

In some embodiments, a method for performing dynamic enhanced maximum likelihood sequence estimation (MLSE) adaptation in a SerDes receiver of an interconnect interface between AI-accelerating processors, the method comprising: receiving modulated signals from an optical channel connecting the AI-accelerating processors, wherein the modulated signals are part of a collective operation between the AI-accelerating processors; performing front-end equalization on the modulated signals to generate post-equalization signals; performing dynamic enhancements of MLSE trellis-based sequence detection on the post-equalization signals, wherein the dynamic enhancements are based on dynamically decoded forward error correction (FEC) results as feedback to account for changing channel conditions of the optical channel between the AI-accelerating processors, wherein the dynamic enhancements of the MLSE trellis-based sequence detection comprise: obtaining the dynamically decoded FEC results for the post-equalization signals, computing corrected symbol paths for the MLSE trellis-based sequence detection that are derived from the dynamically decoded FEC, determining path-distance metrics from mismatch information between received raw signals and the post-equalization signals, inputting the path-distance metrics to a neural network to generate one or more MLSE-related parameters, the one or more MLSE-related parameters comprising data-dependent sigma and a path-selection weighting value, applying the one or more MLSE-related parameters generated by the neural network to the MLSE trellis-based sequence detection to dynamically adjust the MLSE trellis-based sequence detection; and decoding the modulated signals at least partially using the dynamic enhancements to the MLSE trellis-based sequence detection to complete the collective operation between the AI-accelerating processors.

In some embodiments, the front-end equalization comprises one of feed-forward equalization (FFE) and/or a decision feedback equalization (DFE).

In some embodiments, the dynamic enhancements further comprise: obtaining corrected-symbol references derived from dynamically decoded FEC outcomes; and comparing the corrected-symbol references with known reference signals to determine the corrected symbol paths.

In some embodiments, the path-distance metrics include a difference between a maximum-likelihood path and a second-most-likelihood path in at least one recent trellis interval.

In some embodiments, the neural network comprises a multilayer perceptron having at least one hidden layer and at least one nonlinear activation, and wherein the neural network is configured to output at least one of an updated data-dependent sigma value and one or more updated transition-weighting terms.

In some embodiments, the nonlinear activation is tanh.

In some embodiments, the dynamic enhancements further comprise: outputting a desired target path; updating a noise parameter sigma; and applying a correction rule to the desired target path and the noise parameter sigma.

In some embodiments, the path-selection weighting value modifies a relative contribution of candidate-state transition among multiple pulse amplitude modulation (PAM) symbol values in the MLSE trellis-based sequence detection.

In some embodiments, a SerDes receiver for performing dynamic enhanced maximum likelihood sequence estimation (MLSE) adaptation for an interconnect interface between AI-accelerating processors, the receiver comprising: an analog front end configured to receive modulated signals via an optical channel connecting between the AI-accelerating processors, wherein the modulated signals are part of a collective operation between the AI-accelerating processors; an equalizer configured to perform a front-end equalization on the modulated signals to generate post-equalization signals; a signal decoder configured to perform dynamic enhancements of MLSE trellis-based sequence detection on the post-equalization signals, wherein the dynamic enhancements are based on dynamically decoded forward error correction (FEC) results as feedback to account for changing channel conditions of the optical channel between the AI-accelerating processors, wherein the dynamic enhancements of the MLSE trellis-based sequence detection comprise: obtaining the dynamically decoded FEC results for the post-equalization signals, computing corrected symbol paths for the MLSE trellis-based sequence detection that are derived from the dynamically decoded FEC, determining path-distance metrics from mismatch information between estimated symbol paths of the MLSE trellis-based sequence detection and the corrected symbol paths, inputting the path-distance metrics to a neural network to generate one or more MLSE-related parameters, the one or more MLSE-related parameters comprising data-dependent sigma and a path-selection weighting value, applying the one or more MLSE-related parameters generated by the neural network to the MLSE trellis-based sequence detection to dynamically adjust the MLSE trellis-based sequence detection; wherein the signal decoder is configured to decode the modulated signals at least partially using the dynamic enhancements to the MLSE trellis-based sequence detection to complete the collective operation between the AI-accelerating processors.

In some embodiments, the equalizer is configured to comprise one of feed-forward equalization (FFE) and decision feedback equalization (DFE).

In some embodiments, the signal decoder is configured to obtain corrected-symbol references derived from dynamically decoded FEC outcomes, and compare the corrected-symbol references with known reference signals to determine the corrected symbol paths.

In some embodiments, the SerDes receiver, wherein the signal decoder is configured to determine path-distance metrics including a difference between a maximum-likelihood path and a second-most-likelihood path in at least one recent trellis interval.

### BRIEF DESCRIPTION OF THE DRAWINGS

FIG. 1 is a block diagram illustrating an example system embodiment for an interconnected processor cluster, in accordance with some embodiments.

FIG. 2 is a conceptual block diagram illustrating an example communication system that includes a transmitter, a receiver, and a channel between the transmitter and the receiver, in accordance with some embodiments.

FIG. 3 is a block diagram illustrating components and circuitry of a receiver, in accordance with some embodiments.

FIG. 4 is a trellis representation in which successive symbol times are arranged as columns and possible symbol states are arranged as candidate nodes within each column, in accordance with some embodiments.

FIG. 5 provides equations used to modify how a path-selection process behaves when an initially selected path is not the correct path, in accordance with some embodiments.

FIG. 6 illustrates a structure of an example neural network, in accordance with some embodiments.

FIGS. 7A and 7B illustrate experimental results using enhanced MLSE encoding compared to benchmarks, in accordance with some embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The figures (FIGs.) and the following description relate to preferred embodiments by way of illustration only. One skilled in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable, similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview

The disclosed embodiments address a fundamental receiver problem in high-speed SerDes links: channel condition can change during operation and accumulate over time, while conventional decoding parameters often remain too static to reflect current optical or electrical link conditions. In data-center and processor-interconnect environments, modulated signals may be degraded by attenuation, frequency-dependent loss, inter-symbol interference, nonlinear distortion, and data-dependent noise. These effects are especially difficult to manage in multi-level signaling formats such as PAM4 and higher-order schemes, where small shifts in channel behavior can cause a receiver to misidentify symbol sequences and allow decoding errors to persist.

To address these challenges, the disclosure describes a receiver architecture that preserves a high-throughput signal path while adding dynamic adaptation to maximum likelihood sequence estimation (MLSE) trellis-based sequence detection. An analog front end receives the incoming waveform, and an equalizer such as a feed forward equalizer or decision feedback equalizer produces post-equalization signals for downstream processing. The system includes an enhanced MLSE framework that can be dynamically parameterized during live operation to address channel conditions in real time.

In some embodiments, dynamically decoded forward error correction results may be used as a feedback source for ongoing MLSE adaptation. Corrected symbol information derived from FEC may be used to identify when the best estimated symbol path differs from a corrected path. From that comparison, the receiver determines path-distance metrics that reflect how the current MLSE process is ranking candidate paths. Those metrics may also be provided to a neural network, such as a multilayer perceptron with nonlinear activation, which generates updated MLSE-related parameters. In some embodiments, the MLSE-related parameters may include data-dependent sigma values and path-selection weighting terms. The updated parameters are fed back into the MLSE sequence detector so that future path selection more closely tracks the real behavior of the channel. This approach directly addresses the technical difficulty of error propagation in trellis-based detection. When a conventional MLSE process begins favoring an incorrect path, the error can continue across later trellis intervals because the underlying scoring assumptions remain misaligned with the received signal conditions.

By using corrected feedback and path-distance information to adjust noise-related and transition-related parameters, the disclosed receiver can adjust the trellis process away from persistent wrong-path behavior without sacrificing the efficiency of MLSE. The result is a more adaptive form of sequence detection that is better suited to nonlinear and data-dependent impairments than equalization alone or static MLSE parameterization.

The disclosed architecture is particularly relevant to interconnect interfaces between AI-accelerating processors participating in collective operations, where connectivity reliability and throughput are important. In those environments, decoding errors can directly affect parameter exchange, synchronization, and other communication-intensive workloads. By combining front-end equalization, MLSE trellis-based detection, FEC-derived supervision, and neural-network-assisted parameter updates within the receiver, this disclosure provides a practical way to improve decoding robustness under changing channel conditions while preserving the throughput and structural advantages of a high-throughput SerDes receiver.

### Example Data Center

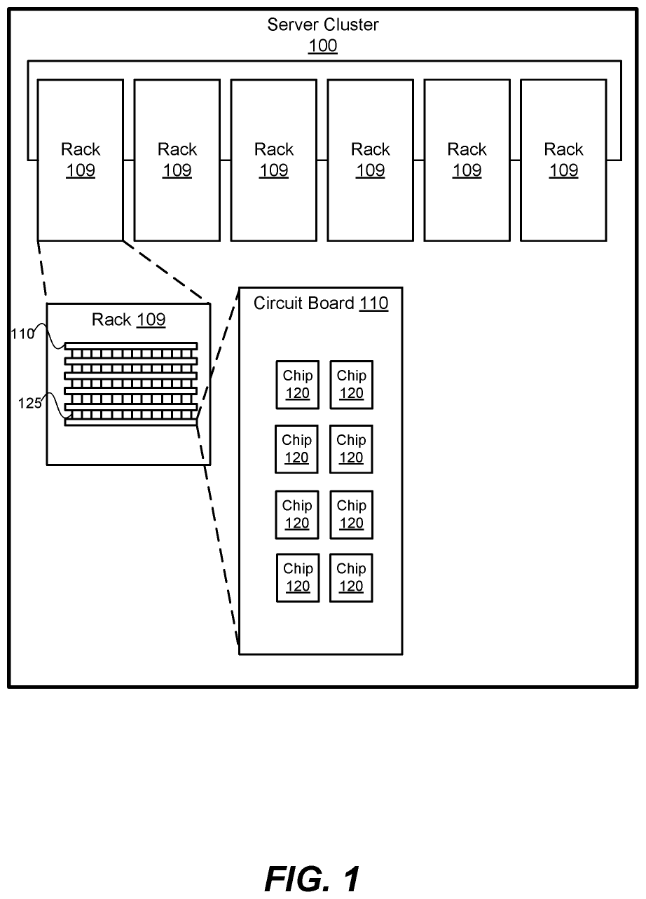

FIG. 1 is a block diagram illustrating an example system embodiment for an interconnected processor cluster, in accordance with some embodiments. A server cluster 100 may represent a group of AI-accelerating processors 120 that coordinate in a distributed compute system to work across a number of physical racks. The AI-accelerating processors 120 may simply be referred to as chips 120.

In some embodiments, a server cluster 100 may supervise workload placement, parallelism, single instruction multiple data (SIMD) instructions and synchronization, and inter-rack traffic management for communication-intensive AI workloads, such as a transformer-based large language model (LLM). The server cluster 100 may provide a logical fabric for distributed execution across racks. In some embodiments, server cluster 100 may be configured to adaptively scale topology by activating or deactivating rack-level paths based on traffic demand, fault policy, and energy policy. Optional control policies may include throttling, rerouting, and priority handling for collective operations. A server cluster 100 may include a number of racks 109.

In some embodiments, a rack 109 may represent a mid-level node that houses local processing and acts as an aggregation point between chip-level endpoints and the broader server cluster 100. In some embodiments, rack 109 may include direct links to other rack 109 elements and may route chip-to-chip or rack-to-rack traffic depending on latency and bandwidth requirements. In some embodiments, rack 109 may expose upward links to server cluster 100 and lateral links to neighboring rack 109 nodes, and these links may be used to spread communication load during distributed model training and inference synchronization tasks, such as parallelism, mixture of experts (MoE) routing, pipelined operations, and other SIMD operations. In some embodiments, a rack 109 may host multiple circuit board 110 resources and may balance local collective exchange with cross-rack forwarding.

In some embodiments, a circuit board 110 may provide a physical domain for placing and electrically connecting multiple chips 120 in close proximity. In some embodiments, circuit board 110 may simplify low-latency neighbor exchange by using short trace lengths and grouped placement of chip 120 resources. A circuit board 110 may support board-level communication domains that feed into rack-level routing paths. In some embodiments, circuit board 110 may allow scalable expansion by adding board-level resources without modifying the rack-level or server cluster-level transport policy, and optional board partitioning may be used to isolate traffic classes or model partitions. In some embodiments, circuit board 110 may route signals to interconnect interface 125 locations that connect to broader fabric paths.

In some embodiments, a chip 120 may represent an AI-accelerating processor 120 that may participate in parallel workload distribution and distributed state exchange with other chip 120 devices in the same or other racks 109. Chips 120 may be interconnect-linked for tasks such as model parameter exchange, partial gradient reduction, tensor partition handoff, and synchronization handshakes used in barrier-style workflows, large matrix multiplication, etc. Interconnection of chips 120 may be motivated by reduced runtime of large-scale AI training stages, lower end-to-end latency for inference pipelines, and improved resource utilization during collective operations. Chip 120 may use multiple link endpoints. Each endpoint may be mapped to alternative channels depending on channel span, reliability needs, and load balancing policy.

In some embodiments, an interconnect interface 125 may represent a channel between any components in FIG. 1, such as a chip-to-chip channel, a board-to-board channel, a rack-to-rack channel, and a longer-ranged channel between server cluster 100. In some embodiments, channel possibilities for interconnects may include optical channels for long-reach, high-capacity transport, and electrical media for compact board-level or rack-level spans. Interconnect interface 125 may support point-to-point links, point-to-multipoint fan-out, switched fabric traversal, and mesh-like multi-path communication between groups of chips 120. Channel topology may be arranged to support collective operations including all-reduce, all-to-all, reduce-scatter, and broadcast patterns, where traffic from multiple chip 120 devices may converge at intermediate rack or board-level levels before returning to destination chip 120 resources. In some embodiments, channel selection may be optional and adaptive so that link usage may reflect distance, congestion, and operational condition without changing the structural hierarchy of server cluster 100, rack 109, circuit board 110, and chip 120.

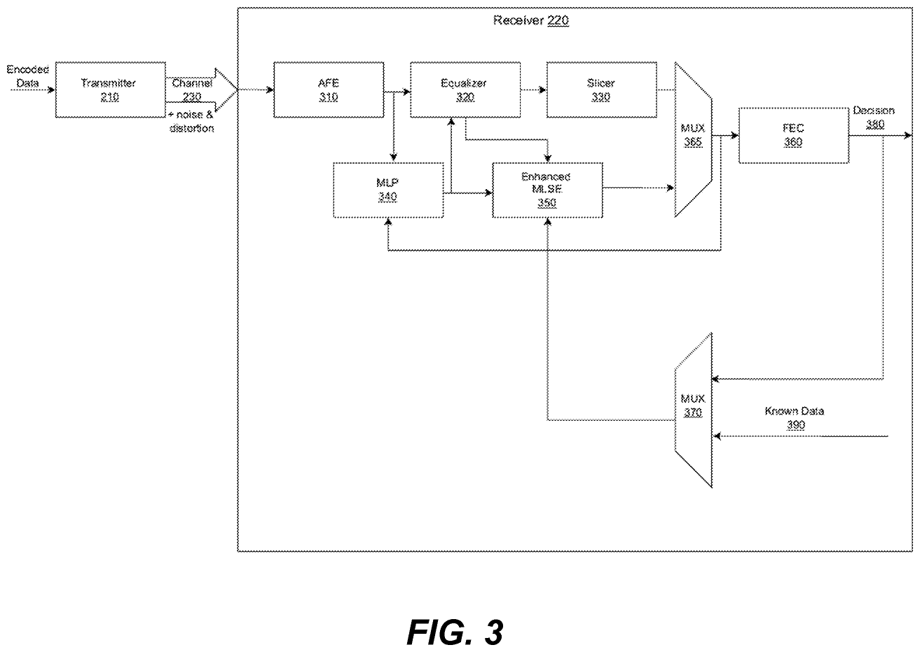

In various embodiments, the communications between components shown in FIG. 1 may be encoded and decoded by an enhanced maximum likelihood sequence estimation (MLSE) system that will be further described in FIG. 3.

### Example Channel

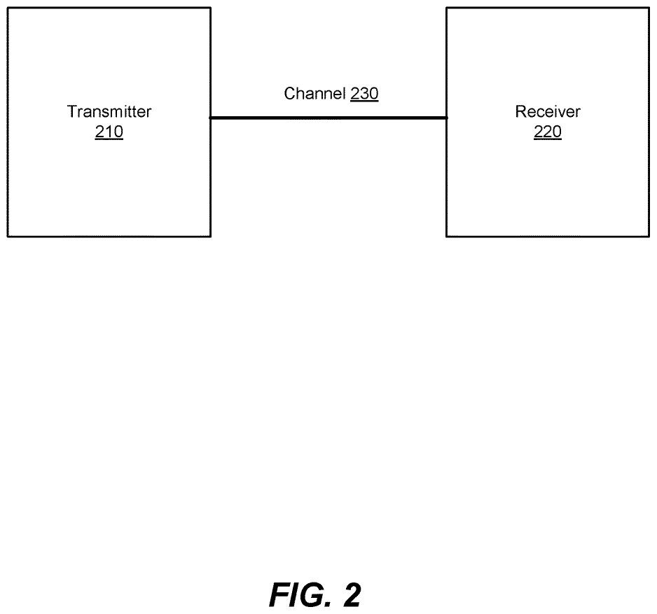

FIG. 2 is a conceptual block diagram illustrating an example communication system that includes a transmitter 210, a receiver 220, and a channel 230 between the transmitter 210 and the receiver 220, in accordance with some embodiments. The communication system may be any suitable connection between two components in FIG. 1, such as a chip-to-chip system, a board-to-board system, a rack-to-rack system, and a longer-ranged channel between server cluster 100. While a server cluster 100 in a data center setting is used as a primary example, the communication system illustrated in FIG. 2 and the enhanced MLSE system illustrated in FIG. 3 may be applied to any communication systems, such as a telecommunication system, including long-reach optical transport links, data-center interconnects, metro/access fiber links, wireless cellular systems, Wi-Fi, LTE, satellite communication links, microwave/millimeter-wave links, fixed point-to-point radio links, visible-light communication links, powerline communication links, and vehicular or industrial communication networks. Without loss of generality, the rest of the disclosure will be described using components in a data center as described in FIG. 1, but one of ordinary skill in the art would understand that this disclosure can also be applied to any communication system.

In some embodiments, a transmitter 210 may represent a source endpoint that formats payload symbols to be transmitted as a signal, such as a modulated signal, through the channel 230 to a receiver 220. The payload may be associated with a collective operation between AI-accelerating processors 120. The transmitter 210 may convert the payload into a modulated waveform for transfer through channel 230. In some embodiments, transmitter 210 may accept digital symbols and apply modulation methods such as multi-level signaling formats, and pulse shaping may be used to match channel characteristics and available bandwidth. In some embodiments, transmitter 210 may map data groups to symbol levels including PAM4 and may extend to higher multi-level formats where link budget and implementation policy permit. Other forms of modulations may include non-return-to-zero (NRZ), PAM2, PAM6, PAM8, phase-shift keying (PSK), quadrature phase-shift keying (QPSK), differential PSK (DPSK), quadrature amplitude modulation (QAM, including 16-QAM and 64-QAM), orthogonal frequency-division multiplexing (OFDM), carrierless amplitude/phase (CAP), frequency-shift keying (FSK), on-off keying (OOK)/amplitude-shift keying (ASK), and other known electrical or optical signaling formats used in short-reach, mid-reach, or long-reach links.

In some embodiments, a channel 230 may represent the physical interconnect path between transmitter 210 and receiver 220. A channel 230 may introduce channel effects that degrade waveform fidelity, such as noise and other channel conditions. Noise and other channel conditions may be modeled as noise terms added to the transmitted waveform. In some embodiments, channel 230 may be modeled with linear and/or non-linear behaviors. A linear behavior may include attenuation, delay, and frequency-dependent response. These effects may be represented by convolutional distortion, frequency-selective fading, inter-symbol interference (ISI), or a simplified linear model. A non-linear behavior may include amplitude-to-phase conversion, saturation, and inter-symbol interaction under high-speed operation.

In some embodiments, a channel 230 may be optical or electrical. A channel 230 may be modeled as a conceptual path, which may represent an optical link for long span or high-capacity transport or an electrical link for compact paths, depending on topology, latency, and cost. By way of example, channels 230 may take the form of chip-to-chip links, die-to-die links, on-package micro-bumps or advanced packaging interposers, short-reach electrical board traces, package-to-backplane traces, twinax or coaxial electrical cables, direct-attach copper links, active or passive optical cables (AOCs), coherent or direct-detection fiber links, co-packaged optics, front-panel breakout cables, intra-rack SerDes lanes (e.g., 50/100/200/400/800 Gb/s electrical interfaces), InfiniBand or Ethernet-based interconnect paths, and commercial multi-chiplet/AI interconnect technologies such as NVIDIA NVLink, AMD Infinity Fabric links, and PCIe/CXL electrical links.

A receiver 220 may represent the destination endpoint that accepts distorted signals from a channel 230 and performs recovery of transmitted information. While in this disclosure the communication may be described as part of a collective operation among the chips 120 in a server cluster 100, in other embodiments the communication may be part of any setting. In some embodiments, a receiver 220 may include demodulation circuitry to identify symbol boundaries and infer the transmitted level sequence from a noisy and distorted waveform. In some embodiments, a receiver 220 may include a front-end signal conditioning stage, such as an equalizer, and decision processing that may compensate for selected distortion effects, such as in decoding, determining most probable paths, and in error correction. In some embodiments, a receiver 220 may produce a recovered signal estimate using an enhanced MLSE circuit or processor that runs an enhanced MLSE algorithm. Further details of an example of receiver 220 will be discussed in FIG. 3 below.

### Example Receiver

FIG. 3 is a block diagram illustrating components and circuitry of a receiver, such as a receiver 220, in accordance with some embodiments.

Encoded data may represent payload information prepared for transmission from one component to another component in the interconnect system. In some embodiments, the encoded data may correspond to information exchanged as part of a collective operation among AI-accelerating processors 120, such as parameter exchange, tensor transfer, synchronization signaling, or other workload-related communication. The encoded data may be arranged for serializer-deserializer processing and may be formatted into digital symbols that can later be mapped to a modulation format for transport through channel 230. While a collective operation is used as a primary example in describing the signal exchange, the receiver architecture may be used in other communication settings and other data center signal exchanges.

In some embodiments, periodically part of the encoded data may also serve as a known reference during adaptation, such as when transmitted data or forward error correction (FEC) decoded data is used to supervise receiver-side adjustment of sequence-detection behavior. For example, the receiver 220 may dynamically enhance maximum likelihood sequence estimation (MLSE) trellis-based sequence detection by comparing the value of the known reference against the decoded value of the reference after the channel 230. The difference and the location of bit errors provide adaptive information on how the channel conditions may have changed.

In some embodiments, a transmitter 210 may receive the encoded data as digital input and may generate a modulated waveform for communication over the channel 230. The transmitter 210 may apply suitable line coding, symbol mapping, and pulse shaping so that the encoded data can be conveyed efficiently within bandwidth and link-budget constraints. By way of example, transmitter 210 may support pulse amplitude modulation (PAM) formats such as PAM4, and may also support other signaling formats including non-return-to-zero, PAM6, PAM8, phase-shift keying, quadrature amplitude modulation, orthogonal frequency-division multiplexing, or other known modulation approaches.

In some embodiments, a channel 230 may be any form of a physical channel, such as an optical channel, a wired channel, or another channel of a suitable physical medium. For example, the channel 230 may take the form of an optical channel connecting between AI-accelerating processors, although the same concepts may also apply to electrical communication media used in serializer-deserializer links. A channel 230 may introduce noise and distortion to the signal and alter the transmitted waveform before the signal reaches a receiver 220. Such effects may include attenuation, delay, frequency-dependent loss, inter-symbol interference, nonlinear distortion, saturation, amplitude-to-phase interaction, and data-dependent noise. These impairments may become especially significant in high-speed multi-level signaling environments, including PAM4 and future PAM6 or PAM8 links, where connectivity is a practical bottleneck in distributed AI systems.

A receiver 220 may represent the destination endpoint that receives a waveform altered by channel 230 and may be configured to recover the transmitted information from that waveform. For example, a receiver 220 may be a SerDes receiver positioned at an interconnect interface between AI-accelerating processors 120 that participate in a collective operation. The modulated signals received by receiver 220 may therefore carry payloads associated with parameter exchange, tensor movement, matrix multiplication, reduction operations, broadcast operations, other SIMD operations, or other communication-intensive tasks within server cluster 100. In some embodiments, a receiver 220 may include demodulation and symbol-recovery circuitry configured to determine symbol timing, identify symbol boundaries, and infer the most likely transmitted symbol sequence from a noisy and distorted received signal.

In some embodiments, a receiver 220 may further include front-end equalization and sequence-detection circuitry that compensates for distortion introduced by channel 230 so that the communication can be reliably completed and at high throughput. The receiver 220 may include an analog front end (AFE) 310 configured to receive the modulated signals, an equalizer 320 configured to generate post-equalization signals, and a signal decoder (which may include a slicer 330, an enhanced MLSE decoder 350, and an error correction component 360) configured to perform dynamic enhancements of MLSE trellis-based sequence detection based on dynamically decoded forward error correction (FEC) results.

An analog front end (AFE) 310 may represent an initial receiver-side interface that accepts the incoming waveform that is an analog signal from channel 230 and conditions that waveform for downstream digital or mixed-signal processing. For example, the AFE 310 may include amplification, filtering, sampling, clock and data recovery support, gain adjustment, impedance matching, or other analog signal-conditioning operations suitable for preparing the received signal for equalization and sequence detection. The AFE 310 may also include an analog-to-digital converter to convert the analog signals to digital data sequences.

In some embodiments, an equalizer 320 may generate post-equalization signals that are then supplied to later receiver stages, including the slicer 330 and the enhanced MLSE decoder 350. The equalizer 320 may be configured as a feed forward equalizer (FFE) or a decision feedback equalizer (DFE). An FFE circuit may include an equalization technique that applies weighted tap coefficients to the incoming signal to compensate for channel distortion using a forward filtering operation. A DFE may refer to an equalization technique that uses prior symbol decisions to cancel post-cursor interference.

In some embodiments, a slicer 330 may compare equalized signal values against one or more decision thresholds to produce tentative symbol decisions or level estimates. For example, when the link uses PAM4 signaling, the slicer 330 may distinguish among four candidate amplitude levels that correspond to different symbol values. These tentative decisions may be useful for receiver processing and may also assist the enhanced sequence-detection flow by providing an initial interpretation of the equalized waveform. In some embodiments, the slicer 330 may be the default decoder of the signal while the enhanced MLSE decoder 350 may be turned on to replace or supplement decoded signals from the slicer 330.

In some embodiments, a multilayer perception (MLP) 340 may receive path-related, signal-related, or error-related inputs and may output one or more MLSE-related parameters, equalizer-related parameters, or both. The MLP 340 may include at least one hidden layer and at least one nonlinear activation. While an MLP is used as an example of architecture of a neural network, in various embodiments, other architectures of neural networks may also be used. In some embodiments, the nonlinear activation may be tanh, although other activations such as sigmoid may also be used depending on the implementation. The use of nonlinear activation functions may allow MLP 340 to model nonlinear channel behavior and data-dependent noise more effectively than a purely linear adaptation process.

In some embodiments, MLP 340 may output various types of MLSE-related parameters. In various embodiments, the examples of MLSE-related parameters may include an updated data-dependent sigma value, one or more updated transition-weighting terms, updated FFE tap coefficients, or a combination thereof. This permits the receiver 220 to adaptively receive parameter values that influence path scoring and equalization behavior. Complexity of the MLP 340 may be managed by selecting the number of hidden layers, the number of nodes, the training rate, and whether pre-training or lower-rate FEC-based updates are used. Accordingly, MLP 340 may provide neural-network-assisted adaptation without imposing the latency, area, throughput, or power penalties on the receiver 220.

In some embodiments, an enhanced MLSE decoder 350 may represent a sequence-detection stage that performs enhanced sequence estimation on the post-equalization signals. The MLSE may refer to a trellis-based detection technique that evaluates candidate symbol paths over time and selects the most likely transmitted sequence based on the received signal and a channel/noise model. The enhanced MLSE decoder 350 may take the form of a dedicated circuit such as an application-specific integrated circuit (ASIC) or other forms of dedicated hardware. In some embodiments, the enhanced MLSE decoder 350 may also take the form of a microcontroller or processor that executes an MLSE algorithm.

In some embodiments, enhanced MLSE decoder 350 may determine path-distance metrics based on a mismatch between an estimated symbol path and a corrected symbol path. This example of a path-distance metric may correspond to a difference between a maximum-likelihood path and a second-most-likelihood path in a recent trellis interval. Those path-distance metrics may be used to directly adjust the enhanced MLSE decoder 350 or may be input to MLP 340 so that the neural network can generate one or more MLSE-related parameters. The updated parameters may then be applied back to enhanced MLSE decoder 350 to dynamically adjust trellis-based sequence detection.

In some embodiments, an enhanced MLSE decoder 350 may update a noise parameter sigma according to a correction rule that is based on outputs of the MLP 340. This process may reduce error-trap behavior in which a conventional detector begins following an incorrect path and continues reinforcing that error over time. In PAM4 implementations, an enhanced MLSE decoder 350 may evaluate transitions among four candidate symbol levels. The enhanced MLSE decoder 350 may also dynamically adjust the path-selection weighting values to modify the relative contribution of candidate-state transitions among those multiple PAM symbol values.

While in this disclosure a primary example of an enhancement of MLSE is described as a dynamic enhancement, in some embodiments, the enhancement of MLSE may also be based on a pre-trained MLP 340. The dynamic nature of the enhancement may not be included in some embodiments. For example, in a pre-trained MLP 340, the MLP 340 may receive pre-equalized signals from the outputs of the AFE 310 to predict MLSE-related parameters to adjust the enhanced MLSE decoder 350.

A forward error corrector (FEC) 360 may take the form of a circuit that is configured to perform a forward error correction stage that decodes redundancy-coded information associated with the received data and provides corrected decoding information for use in dynamic adaptation. Forward error correction (FEC) may refer to an error-control technique in which redundant coding allows the receiver to detect and correct certain errors without retransmission. An example of FEC algorithms or techniques may include block codes, cyclic redundancy assisted correction schemes, Reed-Solomon codes, Bose-Chaudhuri-Hocquenghem codes, low-density parity-check codes, convolutional codes, turbo codes, etc. In some embodiments, the FEC 360 may use one or more hard-decision decoding techniques, soft-decision decoding techniques, algebraic decoding techniques, iterative decoding techniques, or combinations thereof depending on coding overhead, latency target, and channel conditions. For example, Reed-Solomon codes may be used where symbol-level correction is suitable. Low-density parity-check codes may be used where higher-throughput serdes operation or stronger coded-gain behavior is targeted. In some embodiments, FEC 360 may operate after sequence detection from the slicer 330 or from the enhanced MLSE decoder 350 so that receiver decisions can be corrected and refined before being delivered as final recovered data.

In some embodiments, the results of FEC 360 may be used as a feedback source for dynamic MLSE adaptation. For example, dynamically decoded FEC results may provide corrected-symbol references or other corrected data that can be treated as known data for purposes of dynamically adjusting the parameters of the enhanced MLSE decoder 350, training of the MLP 340, and inference of the MLP 340.

In some embodiments, the receiver 220 may obtain corrected symbol paths derived from dynamically decoded FEC outcomes and compare those corrected symbol paths with the estimated symbol paths that are determined as the maximum likelihood sequences. The resulting mismatch information may then be used to compute path-distance metrics, which may be supplied to MLP 340 so that updated MLSE-related parameters can be generated for enhanced MLSE decoder 350. This use of FEC feedback allows receiver adaptation to track changing channel conditions during live operation rather than relying solely on static initial calibration.

The multiplexer (MUX) 365 and MUX 370 may represent multiplexing points used to selectively route signals, decisions, or reference information among the receiver 220 shown in FIG. 3. In some embodiments, one or both multiplexers may control whether a processing path or an enhanced adaptive processing path is used at a given time. For example, a multiplexer may also be used to select between operational data and known data 390, or between intermediate decisions and corrected outputs, so that the receiver can alternate between normal payload recovery, training, calibration, or adaptation modes. Such routing flexibility may support pre-training with known transmitted sequences, supervised updates using FEC-corrected information, and dynamic adaptation based on recent decoded data.

In some embodiments, the MUX 365 may be configured to select between a first decoding path that uses slicer 330 and a second decoding path that uses enhanced MLSE decoder 350. Receiver 220 may turn the enhanced MLSE decoder 350 on or off according to operating conditions. The MUX 365 may route a selected output toward FEC 360 to generate the decision. The slicer 330 may be selected when lower latency, lower power consumption, reduced computational usage, startup operation, or relatively clean channel conditions are present, because slicer 330 may provide a faster symbol decision path based on threshold comparison. Enhanced MLSE decoder 350 may be selected when receiver 220 detects higher noise, stronger inter-symbol interference, nonlinear distortion, data-dependent noise, reduced eye margin, increased bit error rate, or other conditions indicating that a trellis-based sequence decision path may be preferred. For example, receiver 220 may also select enhanced MLSE decoder 350 during calibration, adaptation, training, or degraded-link operation, and may return to slicer 330 during steady-state operation or when channel 230 satisfies a threshold condition for simpler decoding. Accordingly, the MUX 365 may permit receiver 220 to balance speed and decoding quality by selectively routing decisions from slicer 330 or enhanced MLSE decoder 350.

In some embodiments, a decision 380 may represent a recovered output generated by the receiver 220 after equalization, sequence detection, and any applicable error-correction processing. As such, a decision 380 may correspond to the final selected symbol path or decoded payload values. A decision 380 may therefore reflect the originally transmitted encoded data and there can be checksum or other signal checking mechanisms to ensure signal integrity. Where the communication link is part of a collective operation among AI-accelerating processors 120, a decision 380 may correspond to recovered data used to complete synchronization, model exchange, or other distributed computing operations.

In some embodiments, decisions 380 may also be used as part of an ongoing adaptation cycle, for example when recently decoded data is used as feedback for further parameter refinement in MLP 340 and the enhanced MLSE decoder 350.

A known data 390 may represent known reference data string available to the receiver for calibration, supervised adaptation, and/or MLSE path correction. In some embodiments, the known data 390 may correspond to transmitted data whose original values are retained on the receiver 220 for adaptation. The known data 390 may be compared against the decoded result from the current slicer or the current MLSE processing so that the receiver 220 can determine whether the correct path in the enhanced MLSE decoder 350 differs from the presently selected maximum-likelihood path. When a mismatch exists, the receiver 220 may compute a delta or other path-distance metric between the incorrectly selected path and the corrected target path. That metric may then be used to update data-dependent sigma, desired target values, transition-weighting terms, or related MLSE parameters so that the correct path becomes more likely to be selected in subsequent decoding.

In some embodiments, known data 390 may be provided during an initial pre-training phase using deliberate reference transmissions, and in other embodiments it may be derived dynamically from FEC outputs during live operation. This dual role supports both startup calibration and ongoing adaptation to time-varying channel conditions.

### Example Enhanced MLSE

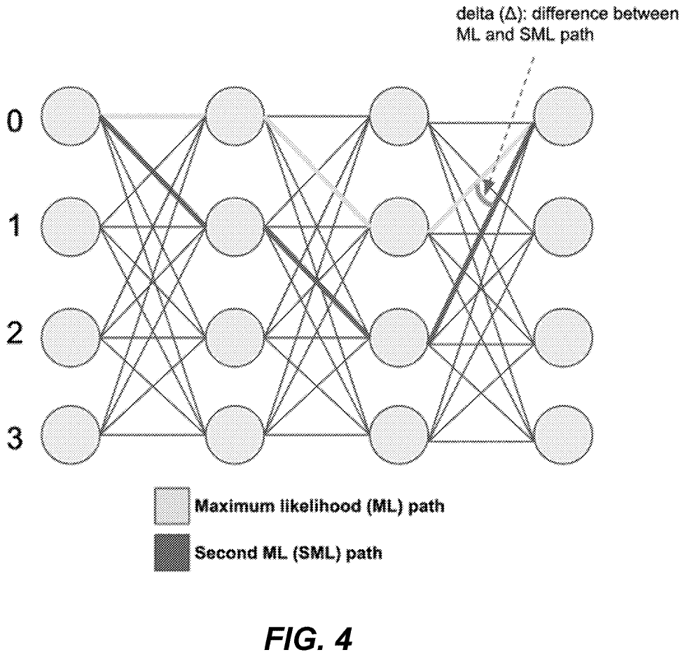

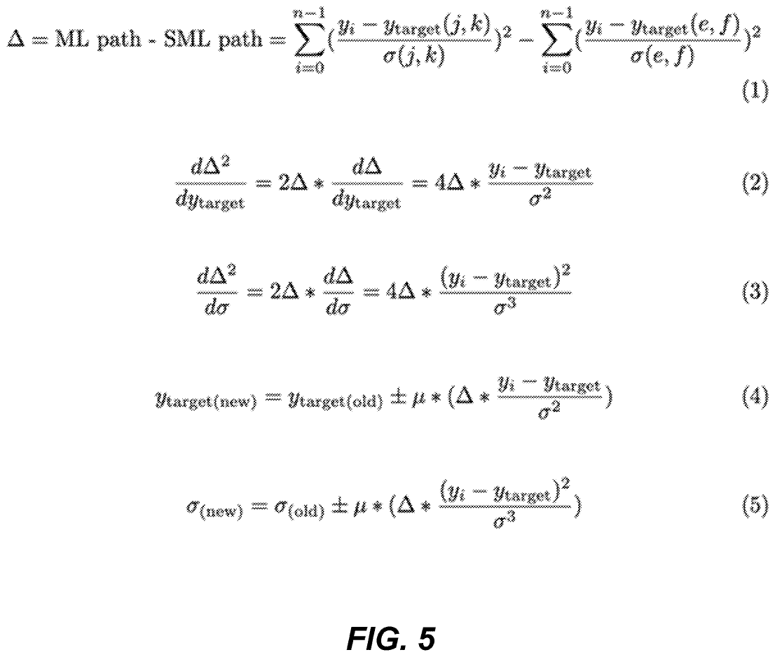

FIG. 4 and FIG. 5 may be understood together as illustrating, respectively, the decision structure of an enhanced MLSE process and the mathematical adaptation process used to enhance that MLSE process.

In some embodiments, FIG. 4 may show a trellis representation in which successive symbol times are arranged as columns and possible symbol states are arranged as candidate nodes within each column. The branches between nodes may represent possible state transitions that correspond to different symbol-sequence hypotheses. In a PAM4 example, each trellis step may involve transitions associated with four candidate symbol values, and the MLSE operation may determine which path through the trellis is most likely to correspond to the originally transmitted data.

In some embodiments, FIG. 4 may illustrate that an MLSE decoder selects a maximum-likelihood path through the trellis based on the received signal and the current channel or noise model. That selected path may be the path that appears most probable under the presently used parameters, even if the selected path is not actually correct because of nonlinear distortion or data-dependent noise. FIG. 4 may further illustrate a known correct path and a selected path as distinct paths through the trellis. For example, the selected path may correspond to a maximum-likelihood path, while the correct path may appear as a second-most-likely path under the current parameter set. The enhanced MLSE approach may use the difference between those competing paths to adjust the parameters used by the enhanced MLSE decoder 350.

In some embodiments, FIG. 5 may mathematically define the quantity represented in FIG. 4 as the distance or delta between the maximum-likelihood path and the correct path. That delta may capture the extent to which the conventional MLSE process prefers an incorrect sequence over the target sequence. The equations in FIG. 5 may therefore formalize the comparison between the path that was selected by the existing MLSE computation and the path that should have been selected based on known data or corrected-symbol information. Where the wrong path is only slightly favored, the corresponding delta may be relatively small. Where the wrong path is strongly favored, the delta may be larger, and a correspondingly larger correction may be applied to the MLSE-related parameters. The equations of FIG. 5 may further define how a desired target value, such as y_{target}, and a data-dependent noise parameter, such as sigma, are updated so that the correct path becomes more likely to win in future trellis evaluations.

In some embodiments, yᵢ may represent a presently obtained value, while y_{target} may represent the value toward which the adaptation process seeks to move the decision behavior. Indices such as j and k may identify trellis positions, states, or branch relationships associated with the compared paths. A step-size or scaling constant, such as μ, may control how strongly the computed delta influences the update. These equations may therefore provide a formal correction rule that shifts the effective MLSE scoring process in an enhanced MLSE decoder 350. Viewed together, FIG. 4 and FIG. 5 may show that the enhanced MLSE process remains a trellis-based sequence detector, but one whose internal parameter behavior is adaptively corrected. FIG. 4 supplies the structural interpretation of the decoding problem by showing the multiple candidate paths through time, while FIG. 5 supplies the update mechanism used when the decoder chooses the wrong one.

In some embodiments, the receiver may obtain known data from transmitted reference data, corrected forward error correction (FEC) results, or other corrected-symbol references. That known information may identify the correct trellis path, and the equations of FIG. 5 may then convert the mismatch between the selected path and the correct path into updated MLSE-related parameters, including data-dependent sigma and path-selection weighting terms.

In some embodiments, the adaptive process illustrated by FIG. 5 may also reduce error-trap behavior that can occur in the trellis illustrated in FIG. 4. An error trap may arise when the detector enters an incorrect path and then continues reinforcing that path across later trellis stages because the current parameters continue to favor the wrong sequence. By computing the mismatch and updating the target-related and noise-related terms, the enhanced MLSE process may alter future branch preferences so that the correct path is more likely to be selected. This may be especially useful in PAM4 and higher-order signaling formats, where symbol density, inter-symbol interference, and nonlinear effects can make conventional MLSE parameterization less reliable. FIG. 4 and FIG. 5 may also support the disclosed hybrid architecture in which machine learning assists MLSE without replacing it. The trellis of FIG. 4 remains the core sequence-detection mechanism. The equations of FIG. 5 define the mathematical quantities that are subject to adaptation, and those quantities may be generated, refined, or influenced by a multilayer perceptron neural network in the receiver.

In some embodiments, a neural network such as MLP 340 may receive path-distance metrics derived from the trellis comparison and may output updated sigma values, updated transition-weighting values, or both. The enhanced receiver may therefore preserve the high-throughput advantages of MLSE while gaining adaptive behavior that better handles nonlinear distortion and data-dependent noise. In this manner, FIG. 4 and FIG. 5 together may describe both the logic and the mathematics of enhanced MLSE adaptation. FIG. 4 may show how candidate symbol sequences compete within a trellis across successive symbol times, and FIG. 5 may show how the receiver mathematically biases that competition toward the correct sequence when known data reveals that the wrong path was selected. The combined disclosure therefore explains how the receiver can dynamically improve sequence detection under changing channel conditions while retaining a conventional MLSE framework.

### Example Neural Network

In various embodiments, a wide variety of machine learning techniques may be used in connection with receiver-side adaptation for high-speed interconnect links between AI-accelerating processors. Examples include different forms of supervised learning, unsupervised learning, and semi-supervised learning such as decision trees, support vector machines (SVMs), regression, Bayesian networks, and genetic algorithms. Deep learning techniques such as neural networks, including convolutional neural networks (CNN), recurrent neural networks (RNN), long short-term memory networks (LSTM), transformers, and linear recurrent neural networks such as Mamba may also be used. For example, various path-distance-metric evaluations and corrected-path comparisons performed by a signal decoder, adaptive parameter generation performed by a neural network such as a multilayer perceptron, and other receiver-side calibration and sequence-detection processes may apply one or more machine learning and deep learning techniques. One or more neural networks (NNs) may be used in various embodiments. An NN may refer to an AI model that includes at least 5 hidden layers, at least 50 learnable computational nodes in the aggregate across the hidden layers, and at least 2,000 trainable parameters, which may include weights, biases, attention tensors, or other learned coefficients.

In some embodiments, the NN may include between 5 and 16 hidden layers. In some embodiments, the NN may include between 16 and 64 hidden layers. In some embodiments, the NN may include between 64 and 256 hidden layers. In some embodiments, the NN may include between 256 and 1,000 hidden layers. In some embodiments, the NN may include more than 1,000 layers. In some embodiments, the number of learnable computational nodes may range from 50 to 1,000. In some embodiments, the number of learnable computational nodes may range from 1,000 to 10,000. In some embodiments, the number of learnable computational nodes may range from 10,000 to one million. In some embodiments, the number of learnable computational nodes may exceed one million. In some embodiments, the total number of trainable parameters may range from 2,000 to 10,000. In some embodiments, the total number of trainable parameters may range from 10,000 to 100,000.

In various embodiments, the training techniques for a machine learning model may be supervised, semi-supervised, or unsupervised. In supervised learning, the machine learning models may be trained with a set of training samples that are labeled. For example, for a machine learning model trained to generate adaptive MLSE-related parameters for sequence detection in a SerDes receiver, the training samples may be paired examples that include received waveform data, post-equalization signals, estimated symbol paths, corrected symbol paths, path-distance metrics, or combinations thereof, together with corresponding target parameter outputs or target decoding outcomes. The labels for each training sample may be binary or multi-class. In training a machine learning model for identifying whether an estimated trellis path should be corrected, the training labels may include a positive label that indicates that the selected path deviates from a corrected symbol path or known reference path and a negative label that indicates that the selected path corresponds to the correct path.

In some embodiments, the training labels may also be multi-class such as different path-correction categories, different symbol-transition classes, or different receiver operating conditions. By way of example, the training set may include multiple past records of received signal traces, equalized symbol sequences, or decoder-state observations with known outcomes. Each training sample in the training set may correspond to a prior received sequence or decoding interval, and the corresponding outcome may serve as the label for the sample. A training sample may be represented as a feature vector that includes multiple dimensions. Each dimension may include data of a feature, which may be a quantized value of an attribute that describes the prior received sequence, decoder state, or channel condition. For example, in a machine learning model that is used to generate updated MLSE-related parameters for enhanced sequence detection, the features in a feature vector may include path-distance metrics, mismatch values between an estimated symbol path and a corrected symbol path, post-equalization sample values, tentative slicer outputs, corrected-symbol references derived from forward error correction, sigma-related values, transition-related values, or other receiver-state information.

In some embodiments, an unsupervised learning technique may be used. The training samples used for an unsupervised model may also be represented by feature vectors, but may not be labeled. Various unsupervised learning techniques such as clustering may be used in determining similarities among the feature vectors, thereby categorizing the training samples into different clusters. In some cases, the training may be semi-supervised with a training set having a mix of labeled samples and unlabeled samples. A machine learning model may be associated with an objective function, which generates a metric value that describes the objective goal of the training process. The training process may intend to reduce the error rate of the model in generating predictions. In such a case, the objective function may monitor the error rate of the machine learning model. In a model that generates predictions, the objective function of the machine learning algorithm may be the training error rate when the predictions are compared to the actual labels. Such an objective function may be called a loss function. Other forms of objective functions may also be used, particularly for unsupervised learning models whose error rates are not easily determined due to the lack of labels.

In some embodiments, in generating adaptive receiver-side parameters for enhanced MLSE sequence detection, the objective function may correspond to one or more performance criteria such as mean square error, bit error rate, cross-entropy loss, path-selection error, or another loss associated with mismatch between predicted parameter outputs or decoding outcomes and corresponding target values.

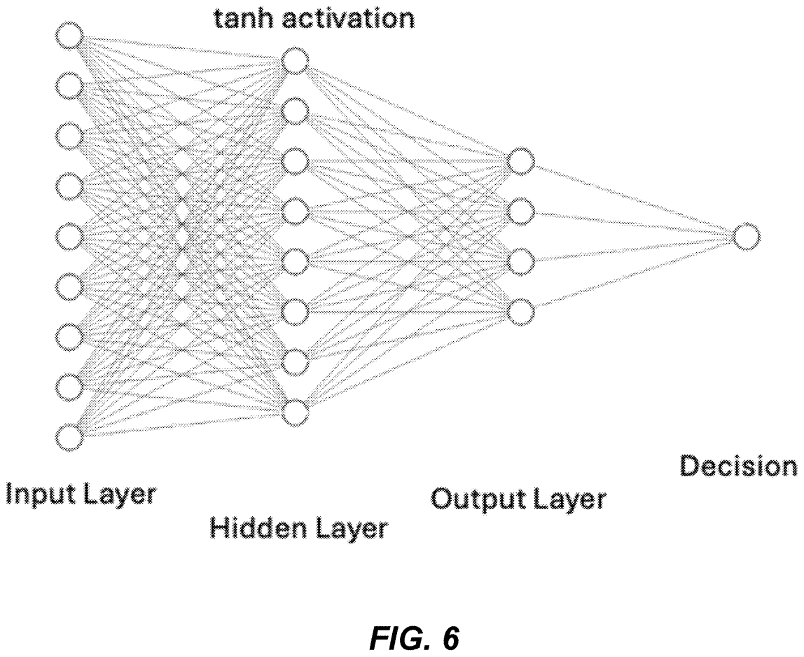

In various embodiments, the error rate may be measured as cross-entropy loss, L1 loss, or L2 loss. Referring to FIG. 6, a structure of an example neural network is illustrated, in accordance with some embodiments. The neural network may take the form of an MLP. The neural network may receive an input and generate an output. The input may be the feature vector of a training sample in the training process and the feature vector of an actual operating case when the neural network is making an inference. The output may be a predicted MLSE-related parameter, a predicted equalizer-related parameter, a predicted decoding adjustment, a predicted classification, or another determination performed by the neural network. The neural network may include different kinds of layers, such as fully connected layers, recurrent layers, convolutional layers, pooling layers, and custom layers. In some embodiments directed to high-speed SerDes receiver adaptation, the neural network may be a multilayer perceptron having an input layer, at least one hidden layer, and an output layer. In one example, the input layer may receive multiple equalizer tap values or path-related features, and the output layer may provide updated feed-forward equalizer tap coefficients, updated data-dependent sigma values, updated transition-weighting terms, or combinations thereof.

In some embodiments, one or more hidden layers may include nonlinear activation functions such as hyperbolic tangent (tanh), sigmoid, Relu, softmax, or another suitable non-linear activation so that the neural network may model nonlinear distortion and data-dependent noise more effectively than purely linear adaptation processes. The order of layers and the number of layers of the neural network may vary in different embodiments.

In various embodiments, the neural network includes one or more layers but may or may not include any pooling layer or recurrent layer. A recurrent layer, if present, may be positioned at different locations. For each layer, the number of nodes and the associated coefficients allowed to be learned may differ from those of other layers. A machine learning model may include certain layers, nodes, kernels, and/or coefficients. Training of a neural network may include forward propagation and backpropagation. Each layer in a neural network may include one or more nodes, which may be fully or partially connected to other nodes in adjacent layers. In forward propagation, the neural network performs the computation in the forward direction based on the outputs of a preceding layer. The operation of a node may be defined by one or more functions. The functions that define the operation of a node may include various computation operations and may also include an activation function that adjusts the weight of the output of the node. Nodes in different layers may be associated with different functions.

Training of a machine learning model may include an iterative process that includes iterations of making determinations, monitoring the performance of the machine learning model using the objective function, and backpropagation to adjust the weights in various nodes. Training may include initial training, fine-tuning, pre-training, post-training, and other different stages of training. A computing device may receive a training set that includes known transmitted symbol sequences, synthetically impaired waveform samples, post-equalization signals, corrected symbol paths derived from forward error correction, recent decoded receiver data, or combinations thereof. Each training sample in the training set may be assigned labels indicating a correct symbol path, a target parameter value, a target decoder output, a target path-selection preference, or another expected adaptation result. The computing device, in a forward propagation, may use the machine learning model to generate predicted parameter values, predicted symbol-path preferences, or predicted decoding outcomes. The computing device may compare the predicted values with the labels of the training sample. The computing device may adjust, in a backpropagation, the weights of the machine learning model based on the comparison. The computing device backpropagates one or more error terms obtained from one or more loss functions to update a set of parameters of the machine learning model.

The backpropagating may be performed through the machine learning model based on a difference between a label in the training sample and the generated predicted value by the machine learning model. By way of example, each of the functions in the neural network may be associated with different coefficients that are adjustable during training. In addition, some of the nodes in a neural network may also be associated with an activation function that decides the weight of the output of the node in forward propagation. Common activation functions may include step functions, linear functions, sigmoid functions, hyperbolic tangent functions, and rectified linear unit functions. After an input is provided into the neural network and passes through the neural network in the forward direction, the results may be compared to the training labels or other values in the training set to determine the neural network's performance. The process of prediction may be repeated for other samples in the training sets to compute the value of the objective function in a particular training round. In turn, the neural network performs backpropagation by using gradient descent such as stochastic gradient descent to adjust the coefficients in various functions to improve the value of the objective function. Multiple rounds of forward propagation and backpropagation may be performed. Training may be completed when the objective function has become sufficiently stable or after a predetermined number of rounds for a particular set of training samples. The trained machine learning model can be used for performing adaptive receiver-side parameter generation for equalization and MLSE sequence detection, or another suitable task for which the model is trained.

In various embodiments, the training samples described above may be refined and used to continue to re-train the model, thereby improving the model's ability to perform inference tasks.

In some embodiments, this training and re-training process may repeat, which results in a computer system that continues to improve its functionality through a use-retraining cycle. For example, after the model is trained, multiple rounds of re-training may be performed. The process may include periodically retraining the machine learning model. The periodic retraining may include obtaining an additional set of training data, such as through deliberate known-data transmission, dynamically decoded forward error correction results, recent receiver decisions, simulated impairment conditions, or other sources. The additional set of training data and later retraining may be based on updated data describing updated receiver states, channel conditions, path-distance metrics, or parameter values in training samples. The process may also include applying the additional set of training data to the machine learning model and adjusting parameters of the machine learning model based on the application of the additional set of training data to the machine learning model. The retraining may be triggered by retraining criteria such as a predictability measure, a bit error rate threshold, a mean square error threshold, a loss-function threshold, or a detected change in channel behavior.

In some embodiments, pre-training may be performed using known transmitted sequences and synthetically impaired examples so that runtime operation begins from a mature parameter state, and later dynamic retraining may refine the model using FEC-derived supervision to track changing channel conditions during live operation.

### Example Experimental Results

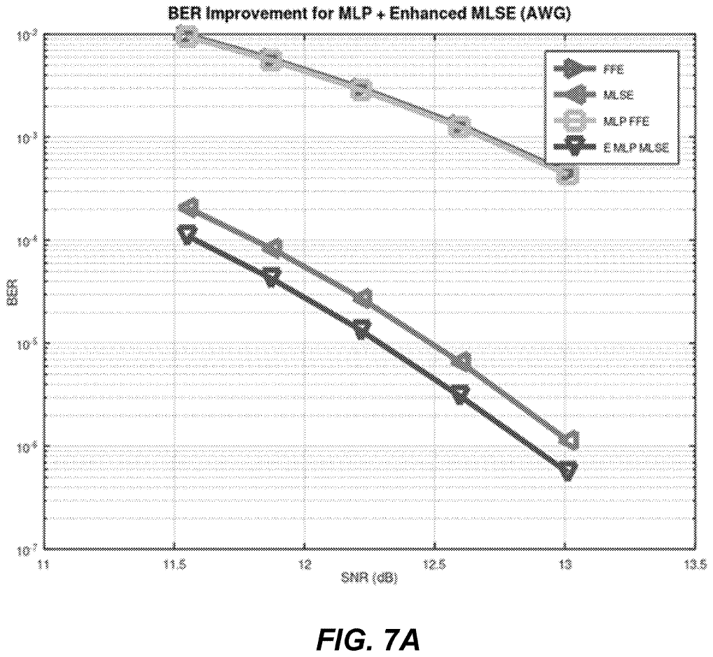

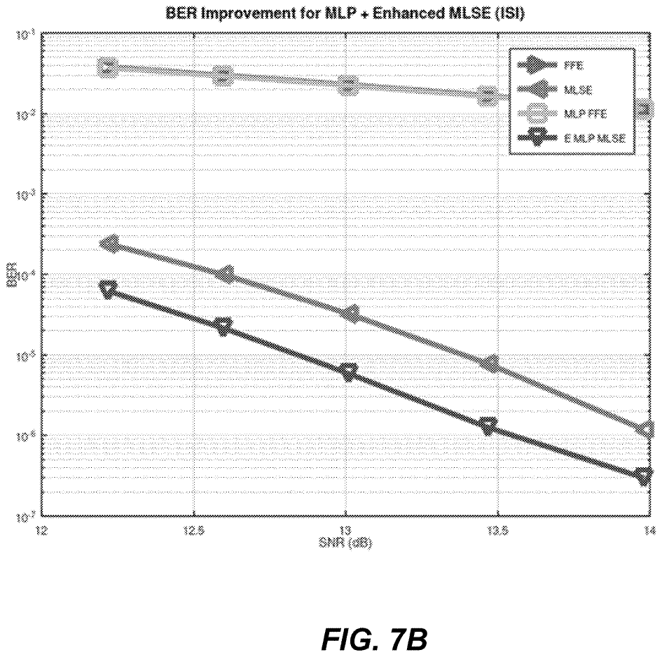

FIG. 7A and FIG. 7B may illustrate experimental performance results comparing multiple receiver decoding approaches, including conventional receiver arrangements and embodiments of the present disclosure that use enhanced MLSE.

In some embodiments, the figures may present bit error rate (BER) behavior for several decoding paths so that the relative benefit of the disclosed receiver architecture can be directly observed. The compared receiver paths may include a baseline feed-forward equalizer (FFE)-based approach, an MLP-assisted equalization approach, a conventional MLSE-based approach, and an enhanced MLSE approach in which machine-learning-assisted adaptation is applied to MLSE-related parameters. These figures may therefore provide empirical support for the disclosed architecture by showing that enhanced MLSE can achieve better decoding performance than conventional receiver decoding techniques under impaired channel conditions.

In some embodiments, FIG. 7A may present a first performance comparison across multiple receiver decoding configurations. The figure shows that a receiver using only FFE has the weakest decoding performance among the tested approaches, which is consistent with the fact that equalization alone may not fully address nonlinear distortion and data-dependent noise. The figure may further show that adding machine-learning assistance to front-end equalization can improve performance modestly relative to FFE alone, but that the improvement from equalizer-only enhancement remains limited when compared with sequence-detection-based approaches. Conventional MLSE may perform better than FFE-based approaches because the MLSE process evaluates symbol sequences through a trellis rather than making only local symbol decisions. However, the figure may show that the disclosed enhanced MLSE achieves the strongest result among the compared curves.

In some embodiments, FIG. 7B may provide a complementary experimental view of the same receiver decoding comparison, such as performance under a different channel condition, operating point, or graphical emphasis. Similar to FIG. 7A, FIG. 7B may demonstrate that the disclosed enhanced MLSE receiver provides superior BER performance relative to conventional decoding paths. The figure may further reinforce that the performance benefit is not merely attributable to the use of machine learning in equalization alone, but instead is more pronounced when machine-learning-assisted adaptation is coupled with MLSE sequence detection. This distinction is important because the present disclosure is directed to enhancing MLSE behavior, including data-dependent sigma updates and path-selection-related adaptation, rather than merely substituting a neural network for a conventional front-end equalizer. Taken together, FIG. 7A and FIG. 7B may show that embodiments using enhanced MLSE provide a measurable reduction in BER relative to an industry-standard FFE plus MLSE baseline.

In some embodiments, the experimental results may correspond to an average BER reduction of approximately 47.88% relative to the conventional baseline. The results may also correspond to a reduction in required signal-to-noise ratio of about 0.21 dB at a BER around 1×(10⁻⁴), with larger gains expected at lower pre-FEC BER regions, such as gains greater than 2 dB near 1×(10⁻¹²). These results indicate that the disclosed adaptive receiver architecture may improve robustness to distortion while preserving the conventional MLSE trellis-search structure.

In some embodiments, the figures may further demonstrate the practical value of combining a conventional receiver pipeline with adaptive parameter generation. The disclosed enhanced MLSE does not replace the MLSE detector with an entirely different neural decoder. Instead, the enhanced MLSE retains the conventional trellis-based sequence detector and improves its operation by adaptively updating MLSE-related parameters based on known data, corrected symbol paths, or neural-network-generated outputs. The superior curves in FIG. 7A and FIG. 7B may therefore be understood as evidence that this hybrid approach provides a more favorable balance of complexity and decoding performance than either equalization alone or conventional MLSE without adaptive enhancement. The experimental results of FIG. 7A and FIG. 7B may be especially relevant for high-speed PAM4 links and other multi-level signaling environments in which nonlinear distortion and data-dependent noise can significantly degrade receiver performance.

In some embodiments, the figures may show that as channel impairment increases, the benefit of the disclosed enhanced MLSE becomes more pronounced because the adaptive receiver is better able to correct path-selection errors and avoid error-trap behavior. This is consistent with the disclosed use of a multilayer perceptron to generate updated MLSE-related parameters, such as data-dependent sigma values and transition-weighting terms, so that the receiver remains aligned with actual channel behavior. Accordingly, FIG. 7A and FIG. 7B may be described as experimental validation of the disclosed receiver architecture. The figures may show that conventional decoding techniques, including FFE-only and conventional MLSE approaches, are outperformed by embodiments that use enhanced MLSE with machine-learning-assisted adaptation. The figures show that post-equalization signals are processed using dynamically enhanced MLSE trellis-based sequence detection, with adaptation based on path-distance metrics, corrected symbol paths, and neural-network-generated parameter updates.

### Additional Embodiments

Embodiment 1. A system for performing dynamic enhanced maximum likelihood sequence estimation (MLSE) adaptation for an interconnect interface between AI-accelerating processors, the system comprising: a plurality of AI-accelerating processors configured to participate in a collective operation; and an interconnection system comprising: an optical channel connecting between two of the AI-accelerating processors; and a SerDes receiver comprising: an analog front end configured to receive modulated signals via the optical channel connecting between the AI-accelerating processors, wherein the modulated signals are part of the collective operation between the AI-accelerating processors; an equalizer configured to perform a front-end equalization on the modulated signals to generate post-equalization signals; a signal decoder configured to perform dynamic enhancements of MLSE trellis-based sequence detection on the post-equalization signals, wherein the dynamic enhancements are based on dynamically decoded forward error correction (FEC) results as feedback to account for changing channel conditions of the optical channel between the AI-accelerating processors, wherein the dynamic enhancements of the MLSE trellis-based sequence detection comprise: obtaining the dynamically decoded FEC results for the post-equalization signals, computing corrected symbol paths for the MLSE trellis-based sequence detection that are derived from the dynamically decoded FEC, determining path-distance metrics from mismatch information between estimated symbol paths of the MLSE trellis-based sequence detection and the corrected symbol paths, inputting the path-distance metrics to a neural network to generate one or more MLSE-related parameters, the one or more MLSE-related parameters comprising data-dependent sigma and a path-selection weighting value, applying the one or more MLSE-related parameters generated by the neural network to the MLSE trellis-based sequence detection to dynamically adjust the MLSE trellis-based sequence detection; wherein the signal decoder is configured to decode the modulated signals at least partially using the dynamic enhancements to the MLSE trellis-based sequence detection to complete the collective operation between the AI-accelerating processors.

Embodiment 2. The system of embodiment 1, wherein the equalizer is configured to comprise one of feed forward equalization (FFE) and decision feedback equalization (DFE).

Embodiment 3. The system of embodiment 1, wherein the signal decoder is configured to obtain corrected-symbol references derived from dynamically decoded FEC outcomes, and compare the corrected-symbol references with known reference signals to determine the corrected symbol paths.

Embodiment 4. The system of embodiment 1, wherein the signal decoder is configured to determine path-distance metrics including a difference between a maximum-likelihood path and a second-most-likelihood path in at least one recent trellis interval.

Embodiment 5. The system of embodiment 1, wherein the neural network comprises a multilayer perceptron having at least one hidden layer and at least one nonlinear activation, and wherein the neural network is configured to output at least one of an updated data-dependent sigma value and one or more updated transition-weighting terms.

Embodiment 6. The system of embodiment 5, wherein the nonlinear activation is tanh.

Embodiment 7. The system of embodiment 1, wherein the signal decoder is configured to further output a desired target path, update a noise parameter sigma, and apply a correction rule to the desired target path and the noise parameter sigma.

Embodiment 8. The system of embodiment 1, wherein the path-selection weighting value modifies a relative contribution of candidate-state transition among multiple pulse amplitude modulation (PAM) symbol values in the MLSE trellis-based sequence detection.

Embodiment 9. A method for performing dynamic enhanced maximum likelihood sequence estimation (MLSE) adaptation in a SerDes receiver of an interconnect interface between AI-accelerating processors, the method comprising: receiving modulated signals from an optical channel connecting between the AI-accelerating processors, wherein the modulated signals are part of a collective operation between the AI-accelerating processors; performing front-end equalization on the modulated signals to generate post-equalization signals; performing dynamic enhancements of MLSE trellis-based sequence detection on the post-equalization signals, wherein the dynamic enhancements are based on dynamically decoded forward error correction (FEC) results as feedback to account for changing channel conditions of the optical channel between the AI-accelerating processors, wherein the dynamic enhancements of the MLSE trellis-based sequence detection comprise: obtaining the dynamically decoded FEC results for the post-equalization signals, computing corrected symbol paths for the MLSE trellis-based sequence detection that are derived from the dynamically decoded FEC, determining path-distance metrics from mismatch information between received raw signals and the post-equalization signals, inputting the path-distance metrics to a neural network to generate one or more MLSE-related parameters, the one or more MLSE-related parameters comprising data-dependent sigma and a path-selection weighting value, applying the one or more MLSE-related parameters generated by the neural network to the MLSE trellis-based sequence detection to dynamically adjust the MLSE trellis-based sequence detection; and decoding the modulated signals at least partially using the dynamic enhancements to the MLSE trellis-based sequence detection to complete the collective operation between the AI-accelerating processors.

Embodiment 10.The method of embodiment 9, wherein the front-end equalization comprises one of feed-forward equalization (FFE) and a decision feedback equalization (DFE).

Embodiment 11.The method of embodiment 9, wherein the dynamic enhancements further comprise: obtaining corrected-symbol references derived from dynamically decoded FEC outcomes; and comparing the corrected-symbol references with known reference signals to determine the corrected symbol paths.

Embodiment 12.The method of embodiment 9, wherein the path-distance metrics include a difference between a maximum-likelihood path and a second-most-likelihood path in at least one recent trellis interval.

Embodiment 13.The method of embodiment 9, wherein the neural network comprises a multilayer perceptron having at least one hidden layer and at least one nonlinear activation, and wherein the neural network is configured to output at least one of an updated data-dependent sigma value and one or more updated transition-weighting terms.

Embodiment 14.The method of embodiment 13, wherein the nonlinear activation is tanh.

Embodiment 15.The method of embodiment 9, wherein the dynamic enhancements further comprise: outputting a desired target path; updating a noise parameter sigma; and applying a correction rule to the desired target path and the noise parameter sigma.

Embodiment 16.The method of embodiment 9, wherein the path-selection weighting value modifies a relative contribution of candidate-state transition among multiple pulse amplitude modulation (PAM) symbol values in the MLSE trellis-based sequence detection.

Embodiment 17. A SerDes receiver for performing dynamic enhanced maximum likelihood sequence estimation (MLSE) adaptation for an interconnect interface between AI-accelerating processors, the receiver comprising: an analog front end configured to receive modulated signals via an optical channel connecting between the AI-accelerating processors, wherein the modulated signals are part of a collective operation between the AI-accelerating processors; an equalizer configured to perform a front-end equalization on the modulated signals to generate post-equalization signals; a signal decoder configured to perform dynamic enhancements of MLSE trellis-based sequence detection on the post-equalization signals, wherein the dynamic enhancements are based on dynamically decoded forward error correction (FEC) results as feedback to account for changing channel conditions of the optical channel between the AI-accelerating processors, wherein the dynamic enhancements of the MLSE trellis-based sequence detection comprise: obtaining the dynamically decoded FEC results for the post-equalization signals, computing corrected symbol paths for the MLSE trellis-based sequence detection that are derived from the dynamically decoded FEC, determining path-distance metrics from mismatch information between estimated symbol paths of the MLSE trellis-based sequence detection and the corrected symbol paths, inputting the path-distance metrics to a neural network to generate one or more MLSE-related parameters, the one or more MLSE-related parameters comprising data-dependent sigma and a path-selection weighting value, applying the one or more MLSE-related parameters generated by the neural network to the MLSE trellis-based sequence detection to dynamically adjust the MLSE trellis-based sequence detection; wherein the signal decoder is configured to decode the modulated signals at least partially using the dynamic enhancements to the MLSE trellis-based sequence detection to complete the collective operation between the AI-accelerating processors.

Embodiment 18.The SerDes receiver of embodiment 17, wherein the equalizer is configured to comprise one of feed-forward equalization (FFE) and decision feedback equalization (DFE).

Embodiment 19.The SerDes receiver of embodiment 17, wherein the signal decoder is configured to obtain corrected-symbol references derived from dynamically decoded FEC outcomes, and compare the corrected-symbol references with known reference signals to determine the corrected symbol paths.

Embodiment 20.The SerDes receiver of embodiment 17, wherein the signal decoder is configured to determine path-distance metrics including a difference between a maximum-likelihood path and a second-most-likelihood path in at least one recent trellis interval.

Embodiment 21. The system of embodiment 1, wherein the front-end equalization is configured to: apply weighted tap coefficients to the modulated signals to compensate for channel distortion using a forward filtering operation; use prior symbol decisions to cancel post-cursor interference; and supply the post-equalization signals to later receiver stages including at least one of a slicer and an enhanced MLSE decoder.

Embodiment 22. The system of embodiment 1, wherein obtaining the dynamically decoded FEC results comprises: performing a forward error correction stage that decodes redundancy-coded information associated with received data; generating corrected decoding information from the redundancy-coded information; and providing corrected-symbol references or other corrected data as a feedback source for the dynamic enhancements of the MLSE trellis-based sequence detection.

Embodiment 23. The system of embodiment 1, wherein computing the corrected symbol paths comprises: obtaining corrected-symbol references derived from dynamically decoded FEC outcomes; comparing the corrected-symbol references with estimated symbol paths determined as maximum likelihood sequences; and identifying a corrected path through a trellis that differs from a presently selected maximum-likelihood path.

Embodiment 24. The system of embodiment 1, wherein determining the path-distance metrics comprises: comparing a maximum-likelihood path selected by an enhanced MLSE decoder with a corrected symbol path derived from the dynamically decoded FEC results; computing a delta between the maximum-likelihood path and the corrected symbol path; and using the delta to indicate an extent to which the MLSE trellis-based sequence detection prefers an incorrect sequence over a target sequence.

Embodiment 25. The system of embodiment 1, wherein the path-distance metrics comprise: a mismatch value between an estimated symbol path and a corrected symbol path; a difference between a maximum-likelihood path and a second-most-likelihood path in at least one recent trellis interval; and a distance or delta that reflects how a current MLSE process ranks candidate paths.

Embodiment 26. The system of embodiment 1, wherein inputting the path-distance metrics to the neural network comprises: forming a feature vector that includes the path-distance metrics; including in the feature vector at least one of mismatch values, post-equalization sample values, tentative slicer outputs, corrected-symbol references, sigma-related values, transition-related values, and receiver-state information; and providing the feature vector to an input layer of the neural network.

Embodiment 27. The system of embodiment 1, wherein the neural network comprises: an input layer configured to receive path-related features; at least one hidden layer configured to apply at least one nonlinear activation; and an output layer configured to provide updated data-dependent sigma values, updated transition-weighting terms, updated feed-forward equalizer tap coefficients, or combinations thereof.

Embodiment 28. The system of embodiment 1, wherein applying the one or more MLSE-related parameters generated by the neural network comprises: updating a data-dependent noise parameter sigma; updating one or more transition-weighting terms; and adjusting branch preferences in the MLSE trellis-based sequence detection so that a corrected symbol path is more likely to be selected.

Embodiment 29. The system of embodiment 1, wherein dynamically adjusting the MLSE trellis-based sequence detection comprises: outputting a desired target path; updating a noise parameter sigma; and applying a correction rule to the desired target path and the noise parameter sigma.

Embodiment 30. The system of embodiment 1, wherein the signal decoder is configured to reduce error-trap behavior by: detecting that the MLSE trellis-based sequence detection has selected an incorrect path; computing mismatch information between the incorrect path and a corrected symbol path; and updating target-related and noise-related terms so that the corrected symbol path is more likely to be selected in subsequent decoding.

Embodiment 31. The system of embodiment 1, wherein the SerDes receiver further comprises a slicer configured to: compare equalized signal values against one or more decision thresholds; produce tentative symbol decisions or level estimates; and provide an initial interpretation of an equalized waveform for receiver processing.

Embodiment 32. The system of embodiment 31, wherein, when the modulated signals use PAM4 signaling, the slicer is configured to: distinguish among four candidate amplitude levels; associate the four candidate amplitude levels with different symbol values; and provide tentative decisions that assist an enhanced sequence-detection flow.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g. method, can be claimed in another claim category, e.g. computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In some embodiments, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed in the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

What is claimed is:

1. A system for performing dynamic enhanced maximum likelihood sequence estimation (MLSE) adaptation for an interconnect interface between AI-accelerating processors, the system comprising:
a plurality of AI-accelerating processors configured to participate in a collective operation; and
an interconnection system comprising:
an optical channel connecting between two of the AI-accelerating processors; and
a SerDes receiver comprising:
an analog front end configured to receive modulated signals via the optical channel connecting between the AI-accelerating processors, wherein the modulated signals are part of the collective operation between the AI-accelerating processors;
an equalizer configured to perform a front-end equalization on the modulated signals to generate post-equalization signals;
a signal decoder configured to perform dynamic enhancements of MLSE trellis-based sequence detection on the post-equalization signals, wherein the dynamic enhancements are based on dynamically decoded forward error correction (FEC) results as feedback to account for changing channel conditions of the optical channel between the AI-accelerating processors, wherein the dynamic enhancements of the MLSE trellis-based sequence detection comprise:
obtaining the dynamically decoded FEC results for the post-equalization signals,
computing corrected symbol paths for the MLSE trellis-based sequence detection that are derived from the dynamically decoded FEC,
determining path-distance metrics from mismatch information between estimated symbol paths of the MLSE trellis-based sequence detection and the corrected symbol paths,
inputting the path-distance metrics to a neural network to generate one or more MLSE-related parameters, the one or more MLSE-related parameters comprising data-dependent sigma and a path-selection weighting value,
applying the one or more MLSE-related parameters generated by the neural network to the MLSE trellis-based sequence detection to dynamically adjust the MLSE trellis-based sequence detection;
wherein the signal decoder is configured to decode the modulated signals at least partially using the dynamic enhancements to the MLSE trellis-based sequence detection to complete the collective operation between the AI-accelerating processors.

2. The system of claim 1, wherein the equalizer is configured to comprise one of feed forward equalization (FFE) and decision feedback equalization (DFE).

3. The system of claim 1, wherein the signal decoder is configured to obtain corrected-symbol references derived from dynamically decoded FEC outcomes, and compare the corrected-symbol references with known reference signals to determine the corrected symbol paths.

4. The system of claim 1, wherein the signal decoder is configured to determine path-distance metrics including a difference between a maximum-likelihood path and a second-most-likelihood path in at least one recent trellis interval.

5. The system of claim 1, wherein the neural network comprises a multilayer perceptron having at least one hidden layer and at least one nonlinear activation, and wherein the neural network is configured to output at least one of an updated data-dependent sigma value and one or more updated transition-weighting terms.

6. The system of claim 5, wherein the nonlinear activation is tanh.

7. The system of claim 1, wherein the signal decoder is configured to further output a desired target path, update a noise parameter sigma, and apply a correction rule to the desired target path and the noise parameter sigma.

8. The system of claim 1, wherein the path-selection weighting value modifies a relative contribution of candidate-state transition among multiple pulse amplitude modulation (PAM) symbol values in the MLSE trellis-based sequence detection.

9. The system of claim 1, wherein the front-end equalization is configured to:
apply weighted tap coefficients to the modulated signals to compensate for channel distortion using a forward filtering operation;
use prior symbol decisions to cancel post-cursor interference; and
supply the post-equalization signals to later receiver stages including at least one of a slicer and the decoder.

10. The system of claim 1, wherein obtaining the dynamically decoded FEC results comprises:
performing a forward error correction stage that decodes redundancy-coded information associated with received data;
generating corrected decoding information from the redundancy-coded information; and
providing corrected-symbol references or other corrected data as a feedback source for the dynamic enhancements of the MLSE trellis-based sequence detection.

11. The system of claim 1, wherein computing the corrected symbol paths comprises:
obtaining corrected-symbol references derived from dynamically decoded FEC outcomes;
comparing the corrected-symbol references with estimated symbol paths determined as maximum likelihood sequences; and
identifying a corrected path through a trellis that differs from a presently selected maximum-likelihood path.

12. The system of claim 1, wherein determining the path-distance metrics comprises:
comparing a maximum-likelihood path selected by the decoder with a corrected symbol path derived from the dynamically decoded FEC results;
computing a delta between the maximum-likelihood path and the corrected symbol path; and
using the delta to indicate an extent to which the MLSE trellis-based sequence detection prefers an incorrect sequence over a target sequence.

13. The system of claim 1, wherein the path-distance metrics comprise:
a mismatch value between an estimated symbol path and a corrected symbol path;
a difference between a maximum-likelihood path and a second-most-likelihood path in at least one recent trellis interval; and
a distance or delta that reflects how a current MLSE process ranks candidate paths.

14. The system of claim 1, wherein inputting the path-distance metrics to the neural network comprises:
forming a feature vector that includes the path-distance metrics;
including in the feature vector at least one of mismatch values, post-equalization sample values, tentative slicer outputs, corrected-symbol references, sigma-related values, transition-related values, and receiver-state information; and
providing the feature vector to an input layer of the neural network.

15. The system of claim 1, wherein the neural network comprises:
an input layer configured to receive path-related features;
at least one hidden layer configured to apply at least one nonlinear activation; and
an output layer configured to provide updated data-dependent sigma values, updated transition-weighting terms, updated feed-forward equalizer tap coefficients, or combinations thereof.

16. The system of claim 1, wherein applying the one or more MLSE-related parameters generated by the neural network comprises:
updating a data-dependent noise parameter sigma;
updating one or more transition-weighting terms; and
adjusting branch preferences in the MLSE trellis-based sequence detection so that a corrected symbol path is more likely to be selected.

17. The system of claim 1, wherein dynamically adjusting the MLSE trellis-based sequence detection comprises:
outputting a desired target path;
updating a noise parameter sigma; and
applying a correction rule to the desired target path and the noise parameter sigma.

18. The system of claim 1, wherein the signal decoder is configured to reduce error-trap behavior by:
detecting that the MLSE trellis-based sequence detection has selected an incorrect path;
computing mismatch information between the incorrect path and a corrected symbol path; and
updating target-related and noise-related terms so that the corrected symbol path is more likely to be selected in subsequent decoding.

19. The system of claim 1, wherein the SerDes receiver further comprises a slicer configured to:
compare equalized signal values against one or more decision thresholds;
produce tentative symbol decisions or level estimates; and
provide an initial interpretation of an equalized waveform for receiver processing.

20. The system of claim 19, wherein, when the modulated signals use PAM4 signaling, the slicer is configured to:
distinguish among four candidate amplitude levels;
associate the four candidate amplitude levels with different symbol values; and
provide tentative decisions that assist an enhanced sequence-detection flow.
